(19) United States
(12) Patent Application Publication
(10) Pub. No.: US 2012/0079430 A1
(43) Pub. Date: Mar. 29, 2012

(54) METHOD FOR PROVIDING A GUI FOR SEARCHING FOR CONTENT, AND DEVICE ADOPTIVING SAME

(76) Inventors: Ji-Young Kwahk, Gyeonggi-do (KR); Giang-yoon Kwon, Seoul (KR); Jin-young Jeon, Seoul (KR); Sang-woong Hwang, Gyeonggi-do (KR); Jee-sun Yoon, Seoul (KR)

(21) Appl. No.: 13/377,459

(22) PCT Filed: Jun. 4, 2010
(86) PCT No.: PCT/KR2010/003587

§ 371 Date: Dec. 9, 2011

(30) Foreign Application Priority Data
Jun. 9, 2009 (KR) 10-2009-0051046

(51) Int. Cl. G06F 3/048

(52) U.S. Cl. 715/834

(57) ABSTRACT

A method and apparatus for providing a Graphic User Interface (GUI) by a display device are provided. The method includes accessing a storage medium including stored content; displaying a GUI item including category indicators along a border region thereof, each of the category indicators corresponding to a type of content, spanning a predetermined range of the boarder region, and including content from the accessed storage medium; displaying a content preview based on a user manipulation of the GUI item; and selecting content from the content preview through the GUI item.

### PRIORITY

This application is a National Phase entry from PCT/KR2010/003587, which was filed on Jun. 4, 2010, and claims priority under 35 U.S.C. §119(a) to a Korean Patent Application Serial No. 10-2009-0051046, which was filed in the Korean Intellectual Property Office on Jun. 9, 2010, the entire disclosure of each of which is hereby incorporated by reference.

### BACKGROUND OF THE INVENTION

1. Field of the Invention

The present invention relates generally to a method and apparatus for providing a Graphic User Interface (GUI), and more particularly, to a method and apparatus for providing a GUI for searching and selecting desired content.

2. Description of the Related Art

With the development of a variety of multimedia device, a user can enjoy various types of multimedia contents using one device. In addition, as technology of a storage device is also development, the user can store a large number of desired contents in high capacity storage device.

However, when the large number of contents is stored in a storage medium, it is difficult for the user to find a desired content among the large number of contents. In addition, it is inconvenient to fine the desired content through manipulations of multiple stages.

When exploring content, the user wants to intuitively search the content easily. Therefore, there is a need for a method for providing a GUI for more intuitive content search.

### SUMMARY OF THE INVENTION

Accordingly, the present invention has been made to solve at least the above-described problems occurring in the prior art, and to provide at least the following advantages.

An aspect of the present invention is to provide a GUI, which displays a GUI item including a specific figure, in which each of one or more categories including contents stored in a selected storage medium is occupied by a predetermined range along a border region thereof and for selecting a category and a content according to a manipulation input by the user, and a device applying the same.

In accordance with an aspect of the invention, a method of providing a Graphic User Interface (GUI) by a display device is provided. The method includes accessing a storage medium including stored content; displaying a GUI item including category indicators along a border region thereof, each of the category indicators corresponding to a type of content, spanning a predetermined range of the boarder region, and including content from the accessed storage medium; displaying a content preview based on a user manipulation of the GUI item; and selecting content from the content preview through the GUI item.

In accordance with an aspect of the invention, a device for displaying content via a Graphic User Interface (GUI) is provided. The device includes a storage unit for storing the content; an interface unit connected to an external storage medium; and a control unit. The control unit accesses the storage medium including the stored content, displays a GUI item including category indicators along a border region thereof, each of the category indicators corresponding to a type of content, spanning a predetermined range of the boarder region, and including content from the accessed storage medium, displays a content preview based on a user manipulation of the GUI item, and selects content from the content preview through the GUI item.

In accordance with an aspect of the invention, a Graphic User Interface (GUI) for displaying and selecting content is provided. The GUI includes a wheel in which different categories of content stored in a storage medium are displayed; a current content mark for indicating content included one of the different categories, based on the rotation of the wheel; and a preview window for displaying a preview of the content indicated by the current content mark.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a screen displaying a wheel type content explorer in a device according to an embodiment of the present invention;

FIG. 2 illustrates a wheel type content explorer in a preview mode according to an embodiment of the present invention;

FIG. 3 illustrates a wheel type content explorer in a list view mode according to an embodiment of the present invention;

FIG. 4 illustrates a touch region of a wheel type content explorer in a preview mode according to an embodiment of the present invention;

FIG. 5 illustrates a touch region of a wheel type content explorer in a list view mode according to an embodiment of the present invention;

FIG. 6 illustrates a touch manipulation that moves a wheel type content explorer according to an embodiment of the present invention;

FIG. 7 illustrates a touch manipulation that expands a wheel type content explorer according to an embodiment of the present invention;

FIG. 8 illustrates a touch manipulation that reduces a wheel type content explorer according to an embodiment of the present invention;

FIG. 9 illustrates a touch manipulation that rotates a wheel type content explorer in a clockwise direction according to an embodiment of the present invention;

FIG. 10 illustrates a wheel type content explorer rotated in a clockwise direction according to an embodiment of the present invention;

FIG. 11 illustrates a wheel type content explorer in which a content ‘Image 20’ is selected in a preview mode according to an embodiment of the present invention;

FIG. 12 illustrates a wheel type content explorer in which a content ‘Image 20’ is selected in a list view mode according to an embodiment of the present invention;

FIG. 13 illustrates a wheel type content explorer in which a content ‘Document 01’ is selected in a list view mode according to an embodiment of the present invention;

FIG. 14 illustrates a wheel type content explorer in which a content ‘Document 01’ is selected in a preview mode according to an embodiment of the present invention;

FIG. 15 illustrates a user input manipulation to rotate a category wheel when a content ‘Image 01’ is selected according to an embodiment of the present invention;

FIG. 16 illustrates a tab manipulation to a content ‘Document 02’ of a thumbnail list when a content ‘Document 01’ is selected according to an embodiment of the present invention;

FIG. 17 illustrates a flick manipulation to a left direction to a preview window according an embodiment of the present invention;

FIG. 18 illustrates a flick manipulation to an up direction to a thumbnail list according an embodiment of the present invention;

FIG. 19 illustrates a wheel type content explorer in which a content ‘Document 23’ is selected according to an embodiment of the present invention;

FIG. 20 illustrates a touch manipulation to rotate a category wheel in a counterclockwise direction according to an embodiment of the present invention;

FIG. 21 illustrates a content list window scrolled to a top direction according to an embodiment of the present invention;

FIG. 22 illustrates a flick manipulation of a top direction to a content list window according to an embodiment of the present invention;

FIG. 23 illustrates a wheel type content explorer when a content ‘Document_07’ is selected according to an embodiment of the present invention;

FIG. 24 illustrates a user dragging and dropping ‘Image 2’ of a thumbnail list to a background image with respect to a wheel type content explorer in a preview mode according to an embodiment of the present invention;

FIG. 25 illustrates a double tap manipulation to a preview window with respect to a wheel type content explorer in a preview mode according to an embodiment of the present invention;

FIG. 26 illustrates a user dragging and dropping ‘Document 02’ of a content list window to a background image with respect to a wheel type content explorer in a list view mode according an embodiment of the present invention;

FIG. 27 illustrates a double tap manipulation to a ‘Document 04’ of a content list window to with respect to a wheel type content explorer in a list view mode according to an embodiment of the present invention;

FIG. 28 illustrates a user dragging and dropping content to be executed in a separate window by a wheel type content explorer according to an embodiment of the present invention;

FIG. 29 illustrates a wheel type content explorer when dragged and dropped content is stored according to an embodiment of the present invention;

FIG. 30 illustrates a user touching a content delete icon when a content ‘Image 01’ is selected according to an embodiment of the present invention;

FIG. 31 illustrates a screen displaying a delete confirm message according to an embodiment of the present invention;

FIG. 32 illustrates a screen displaying a delete animation according to an embodiment of the present invention;

FIG. 33 illustrates a wheel type content explorer after a content ‘Image 01’ is deleted according to an embodiment of the present invention;

FIG. 34 illustrates a screen displaying a storage medium display icon and a wheel type content explorer according to an embodiment of the present invention;

FIG. 35 is a flow chart illustrating a method of providing a GUI according to an embodiment of the present invention; and

FIG. 36 is a block diagram of a device for providing a GUI according to an embodiment of the present invention.

### DETAILED DESCRIPTION OF EMBODIMENTS OF THE PRESENT INVENTION

Various embodiments of the present invention will be described in detail below with reference to the accompanying drawings. In the following description, specific details such as detailed configuration and components are merely provided to assist in the overall understanding of the embodiments of the present invention. Therefore, it should be apparent to those of ordinary skill in the art that various changes and modifications of the embodiments described herein can be made without departing from the scope and spirit of the invention. In addition, descriptions of well-known functions and constructions are omitted for clarity and conciseness.

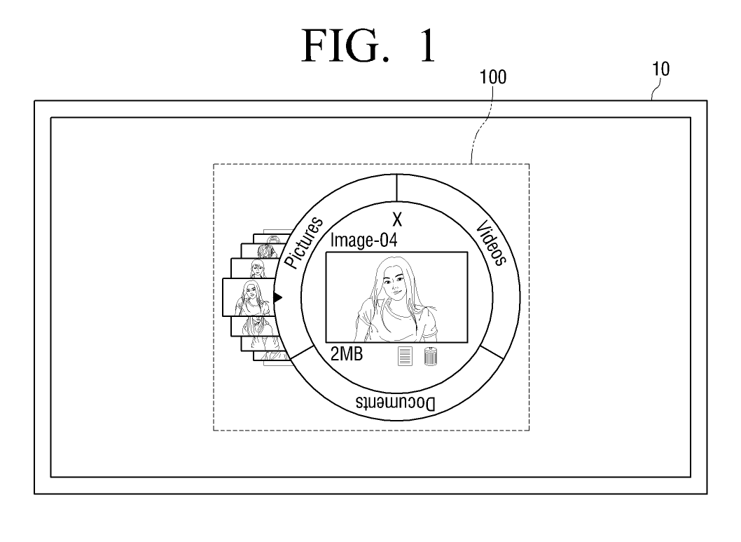

FIG. 1 illustrates a screen displaying a wheel type content explorer in a device according to an embodiment of the present invention.

Referring to FIG. 1, when a user explores content, a device 10 displays a wheel type content explorer 100 on a screen.

The wheel type content explorer 100 is a content search tool for exploring content stored in a storage medium using a wheel type GUI. The wheel type content explorer 100 performs content exploration when a user touches and rotates a wheel through a touch manipulation. Therefore, a device implemented with the wheel type content explorer 100 includes a touch screen as a manipulation device of a user.

For example, the storage medium may be a storage medium built in the device 10 or an external storage medium such as a hard disc, a memory, a Compact Disc-Read Only Memory (CD-ROM), a Digital Versatile Disc (DVD), a Universal Serial Bus (USB) memory, an external memory card, etc.

As illustrated in FIG. 1, the wheel type content explorer 100 classifies content stored in a storage medium by category and displays the classified content. A preview of a file currently selected is displayed inside the wheel. Thus, when the wheel type content explorer 100 is used, a user easily recognizes the amount of files per category stored in the storage medium.

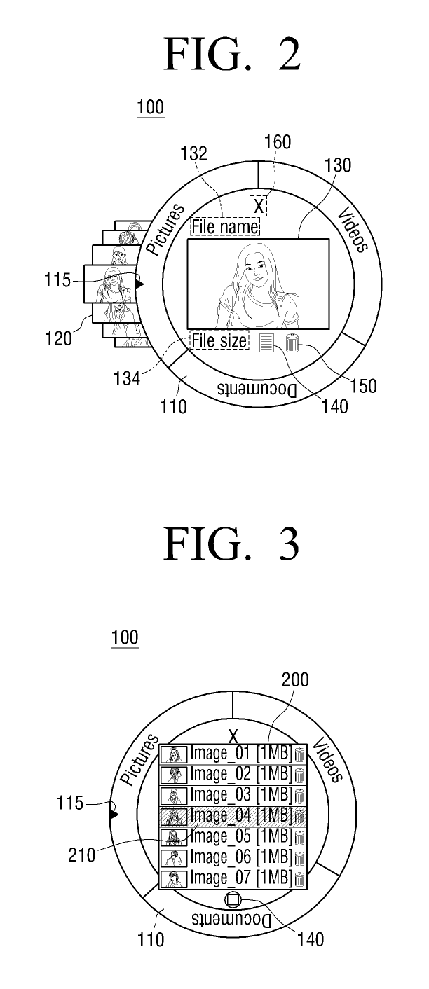

FIG. 2 illustrates a wheel type content explorer in a preview mode according to an embodiment of the present invention.

Referring to FIG. 2, the wheel type content explorer 100 includes a category wheel 110, a current content mark 115, a thumbnail list 120, a preview window 130, a file name display column 132, a file size display column 134, a mode switch icon 140, a delete icon 150, and a shutdown icon 160. The category wheel 110 is a wheel-shaped GUI in which a ratio for each category of stored content is visually displayed. That the category wheel 110 displays each of the categories including the content stored in the storage medium in a predetermined range along a border region. For example, in FIG. 2, the predetermined range is the border region of the category wheel 110.

The device 10 may determine the predetermined range according to a ratio of the number of content of one category to the total number of the content stored in the storage medium.

The device 10 displays categories to be occupied a region of the category wheel 110 by a predetermined range corresponding to each category.

In FIG. 2, three categories, Pictures, Videos, and Document, are displayed in the category wheel 110. A ratio of a size of a region in which each category occupies the category wheel to the total region of the category wheel 110 denotes a ratio of the number of contents corresponding to each category to the total number of the contents. For example, when the total content is 100 items, with 50 Pictures, 30 Videos, and 20 Documents, Pictures occupy a region corresponding to 50% of the border region of the category wheel 110, Videos occupy a region corresponding to 30% of the border region of the category wheel, Documents occupy a range corresponding to 20% of the border region of the category wheel 110.

In addition, when a ratio of the number of content in a specific category is equal to or smaller than a critical ratio, the device 10 displays the specific category to occupy a region corresponding to the preset critical ratio. That is, the ratio of the number of the contents of the specific category to the total number of the contents is lower than the critical ratio, the predetermined range is determined to a range corresponding to the critical ratio.

For example, if the critical ratio is 10%, when the ratio of the number of the content of the specific category is equal to or lower than 10%, the device 10 displays the specific category to occupy a range corresponding to 10% of the category wheel 110. For example, when the critical ratio is 10% and the total content is 100, with 50 Pictures, 49 Videos, and 1 Document is 1, the device 10 displays the content for Documents in a region corresponding to 10% of the border region of the category wheel 110, and then divides the region corresponding to the remaining 90% of border region of the category wheel 110 into the ratio of 50:49 and displays the Pictures in a region corresponding to the ratio of 50 of the category wheel 110 and the Videos in a region corresponding to the ratio of 49 of the category wheel 110. This makes it easier for user to touch a specific category, even when the number of the content of the specific category is very small and thus the content of the specific category is displayed in a very small size.

The category wheel 110 visually displays the category that the content belongs to or amount of the content for each category. Therefore, the user can quickly recognize how many kinds of categories are stored in the storage medium and the amount of content stored in each category.

In addition, the user rotates the category wheel using a touch manipulation and positions a region in which a desired category is indicated in a current content mark 115, to intuitively select the desired category.

Although FIG. 3 illustrates a category wheel including three categories, i.e., Pictures, Videos, and Documents, the category wheel may be configured with more than three categories, and with different types of categories, e.g., a music category, a game category, etc.

The current content mark 115 indicates a position of content currently selected in the category wheel 110. That is, the current content mark 115 becomes a reference point of a content selection using the category wheel 110.

Referring to FIG. 2, the current content mark 115 is displayed in the middle of a thumbnail list 120 at one side of the category wheel 110.

As described above, a user can precisely select the desired content using the thumbnail to list 120. That is, after the user selects an approximate position using the category wheel 110, the user may select the desired content using the thumbnail list 120 in detail.

The preview window 130 indicates the content currently selected by the wheel type category wheel 110. A file name and a file size of the currently selected content may be displayed together with a file name display column 132 and a file size display column 134 in the preview window 130. The device 10 displays content of the currently selected content in the preview window 130. In addition, the device 10 displays the file name and file size in the file name display column 132 and the file size display column 134, respectively.

When the current selected content is a video, the device 10 displays a scene of the video in the preview window 130 or reproduces the video in the preview window 130. When the current selected content is an image, the device 10 displays the selected image in the preview window 130. In addition, when the current selected content is a document, the device 10 displays the document in the preview window 130.

The mode switch icon 140 switches a mode of the wheel type content explorer 100. Basically, the switch icon 140 corresponds to a toggle icon that switches the mode of the wheel type content explorer 100 between the preview mode and the list view. That is, when the user touches the mode switch icon 140, the device 10 switches the mode of the wheel type content explorer 100 between the preview mode and the list view mode. In FIG. 2, the mode of the wheel type content explorer 100 is in the preview mode. Therefore, when the user touches the mode switch icon 140, the device 10 switches the wheel type content explorer 100 from the preview mode to the list view mode. The list view mode is illustrated in FIG. 3 and is a mode in which a content list window 200 is displayed in the center of the category wheel 110.

The delete icon 150 deletes the currently selected content.

The shutdown icon 160 shuts down the wheel type content explorer 100.

FIG. 3 illustrates a wheel type content explorer in a list view mode according to an embodiment of the present invention.

Referring to FIG. 3, the wheel type content explorer 100 is in the list view mode. The content list window 200 displays a predetermined number of content items corresponding to a point selected by the current content mark 115 of the category wheel 110 in a list form. Here, the list includes a plurality of items. Each item of the list includes a thumbnail, a file name, a file size, and a delete icon of a corresponding content.

As illustrated in FIG. 3, the content list window 200 displays an item for a content currently selected by the category wheel 110 in the center thereof with a highlight 210.

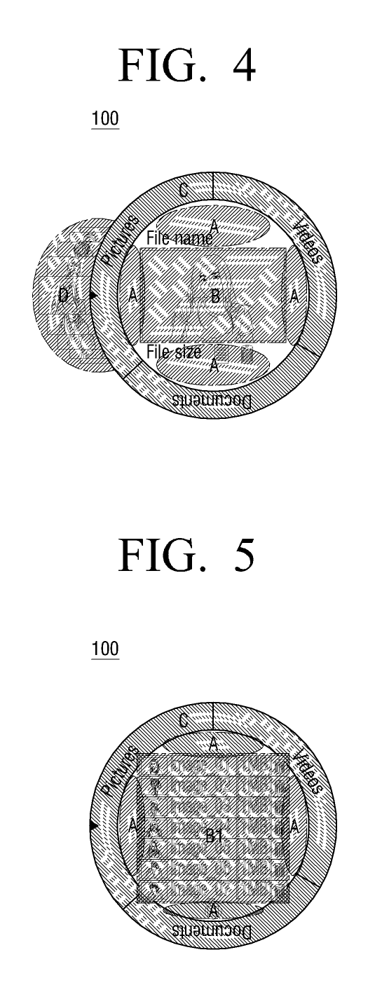

FIG. 4 illustrates a touch region of a wheel type content explorer in a preview mode according to an embodiment of the present invention.

Referring to FIG. 4, in the wheel type content explorer 100 of the preview mode state, the touch region is configured into a region A, a region B, a region C, and a region D. Here, the touch region denotes a region in which a touch manipulation of a specific way performs the same function. Therefore, the touch region is classified on the basis of function performed by the specific touch manipulation.

The region A is a touch region that receives a touch manipulation to move, expand/reduce, or rotate the content explorer 100. Specifically, when the user touches the region A and inputs a drag and drop manipulation, the content explorer 100 moves a starting point of the drag and drop manipulation to an ending point of the drag and drop manipulation. Here, the drag and drop manipulation denotes a manipulation in which the wheel explorer 100 moves with touching the specific icon and then ends the touch.

In addition, when the user inputs a manipulation by touching the region A with two fingers and pans the two fingers toward the outside of the content explorer 100, a size of the wheel explorer 100 is expanded.

Alternatively, when the user inputs a manipulation by touching the region A with two fingers and then pans the two fingers toward the inside of the content explorer 100, the size of the content explorer 100 is reduced. Here, the panning manipulation denotes a touch manipulation of moving with touching a specific point by a finger.

In addition, when the user inputs a manipulation by panning two fingers in a clockwise direction or in a counterclockwise direction while touching the region A by the two fingers, the content explorer 100 rotates.

The region B is a touch region that receives a touch manipulation for searching for and executing content. For example, when the user inputs a tap manipulation to the region B while a video or a music file is displayed in the preview window 130, the displayed video or music file is reproduced in the preview window 130. Here, the tap manipulation denotes a manipulation in which a specific point is touched and then detached.

In addition, when the user inputs a double tap manipulation while the selected content is displayed in the preview 130, the selected content is displayed in a separate window of the background image. Here, the double tap manipulation denotes a touch manipulation in which the tap manipulation is input shortly twice at a moment.

In addition, when the user inputs a flick manipulation to the left or right in the region B while the selected content is displayed in the preview window 130, a previous content is selected or next content is selected, respectively. Here, the flick manipulation denotes a touch manipulation of touching the touch screen like turning over pages of a book and detaching from the touch screen with moving slightly to a specific direction. For example, when the user inputs a flick manipulation to the left in the region B, the previous content is displayed in the preview window 130. Alternatively, when the user inputs a flick manipulation to the right direction, the next content is displayed in the preview window 130.

The region C is a touch region that receives a touch manipulation to rotate the category wheel 110. When the user inputs the panning manipulation of the clockwise direction or the counterclockwise direction to the region C along the category wheel 110, the category wheel 110 rotates in the clockwise direction or the counterclockwise direction according to the panning manipulation.

The region D is a touch region that receives a touch manipulation to control the thumbnail list 120.

When the user input a tab manipulation to any of the content displayed in the thumbnail list 120 of the region D, the thumbnail list 120 is rearranged such that the content to which the tab manipulation is input is displayed in the middle thereof.

In addition, when the user inputs the double tab manipulation to any of the content displayed in the thumbnail list 120 of the region D, the content to which the double tab manipulation is input is executed in a separate window of the background image.

When the user inputs a flick manipulation in a top direction or a bottom direction to the thumbnail list 120 of the region D, the thumbnail list 120 is scrolled in the top direction or the bottom direction.

When the user inputs the drag and drop manipulation in which any of the content displayed in the thumbnail list 120 of the region D is dragged and dropped to the background image, the dragged and dropped content is executed in a separate window.

As described above, the wheel type content explorer 100 in the preview mode state provides various functions according to the type of touch input of the user.

FIG. 5 illustrates a touch region of a wheel type content explorer in a list view mode to according to an embodiment of the present invention.

Referring to FIG. 5, the wheel type content explorer 100 in the list view mode includes a touch region of a region A, a region B1, and a region C. The region A and the region C of FIG. 5 function as described in FIG. 4.

The region B1 is a touch region that receives a touch manipulation to search and execute content of the content list window 200.

When the user inputs the panning manipulation or the flick manipulation in the top direction or in the bottom direction to the region B1, the list of the content list window 200 is scrolled in the top direction or the bottom direction.

In addition, when the user inputs the drag and drop manipulation in which any one of the content displayed in the content list window 200 of the region B1 is dragged and dropped to the background image, the dragged and dropped content is executed in a separate window of the background image.

When the user inputs the double tap manipulation to any of the content displayed in the content list window 200 of the region B1, the content in which the double tap manipulation is input is executed in a separate window of the background image.

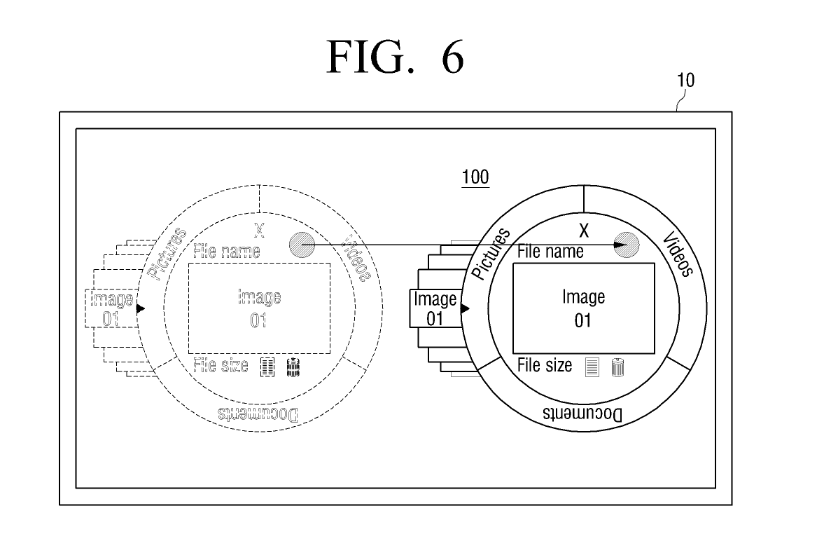

FIG. 6 illustrates a touch manipulation that moves a wheel type content explorer according to an embodiment of the present invention.

Referring to FIG. 6, a user inputs a drag and drop manipulation to the region A (see FIG. 4) to move the wheel type content explorer. That is, when the user inputs the drag and drop manipulation to the region A (see FIG. 4), the device 10 moves the wheel type content explorer 100 to a point in which the drag and drop is ended.

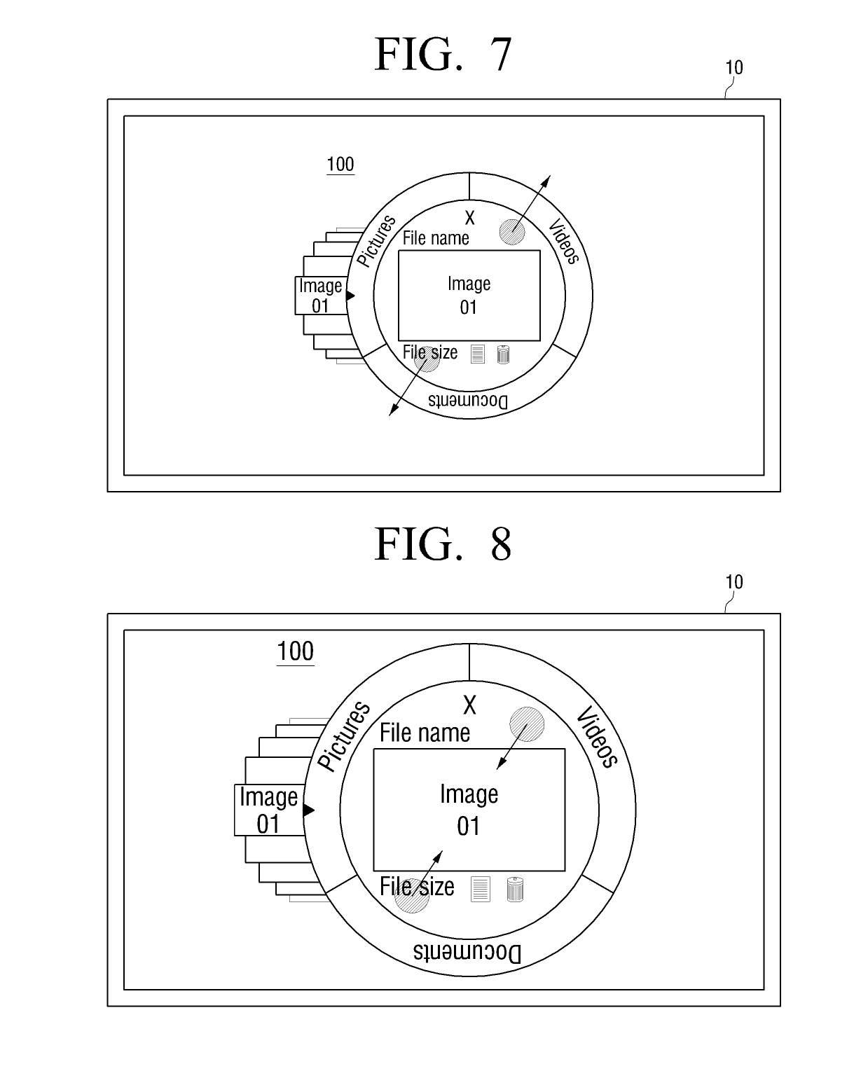

FIG. 7 illustrates a touch manipulation that expands a wheel type content explorer according to an embodiment of the present invention.

FIG. 8 illustrates a touch manipulation that reduces a wheel type content explorer according to an embodiment of the present invention.

Referring to FIG. 7, when the user moves two fingers thereof toward the outside of the category wheel while simultaneously touching an upper region and a bottom region of the region A using the two fingers, the content explorer 100 is expanded as illustrated in FIG. 8.

As illustrated in FIG. 8, when the user moves the two fingers toward inside of the category wheel while simultaneously touching the upper and lower regions of the region A by the two fingers, the content explorer is reduced as illustrated in FIG. 7.

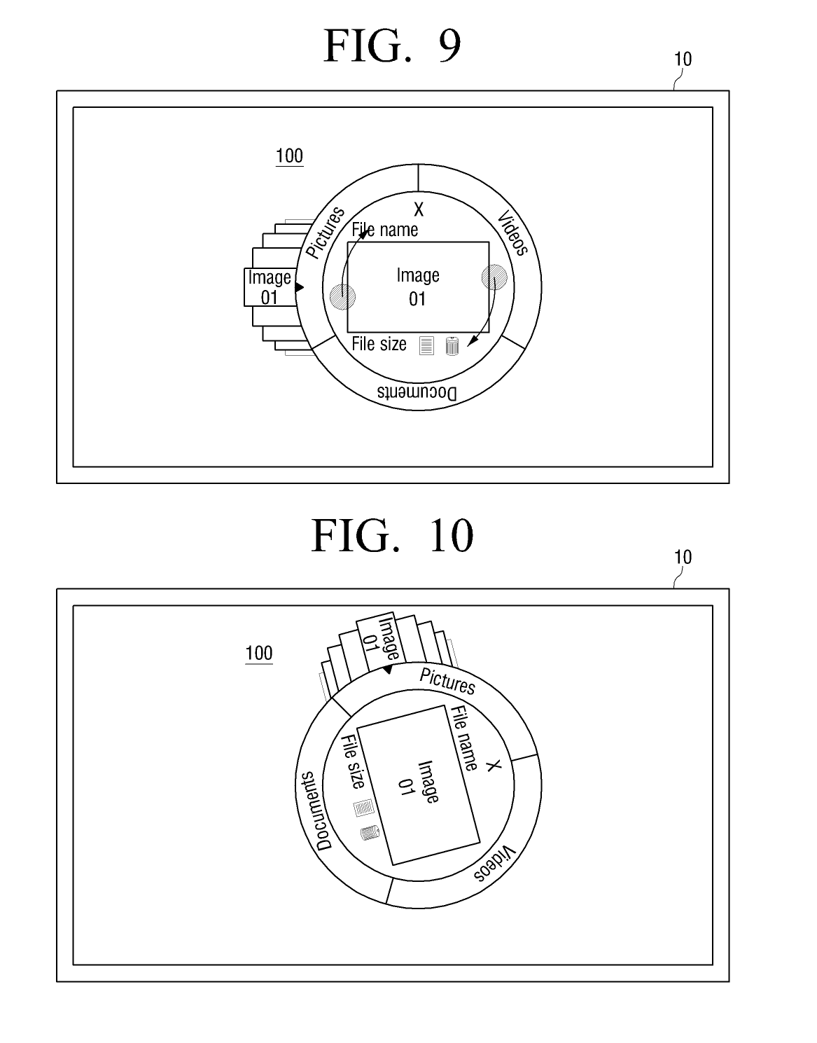

FIG. 9 illustrates a touch manipulation that rotates a wheel type content explorer in a clockwise direction according to an embodiment of the present invention.

FIG. 10 illustrates a wheel type content explorer rotated in a clockwise direction according to an embodiment of the present invention.

Referring to FIG. 9, when the user moves two fingers in the clockwise direction while touching a left region and a right region of the region A with the two fingers, the wheel type content explorer 100 rotates in the clockwise direction. By the above manipulation, the wheel type content explorer 100 is displayed in the rotated state as illustrated in FIG. 10. Similarly, the user can rotate the content explorer 100 in the clockwise direction.

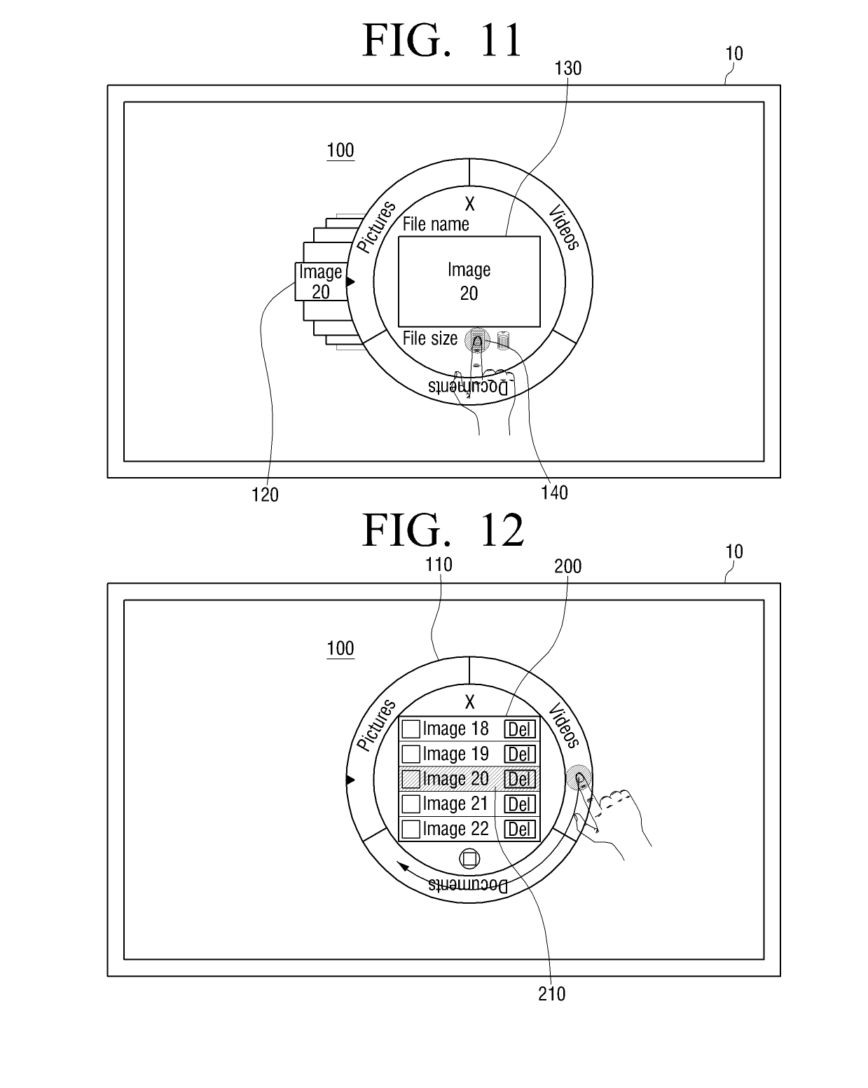

FIG. 11 illustrates a wheel type content explorer in which a content ‘Image 20’ is selected in a preview mode according to an embodiment of the present invention.

FIG. 12 illustrates a wheel type content explorer in which a content ‘Image 20’ is selected in a list view mode according to an embodiment of the present invention.

FIG. 13 illustrates a wheel type content explorer in which a content ‘Document 01’ is selected in a list view mode according to an embodiment of the present invention.

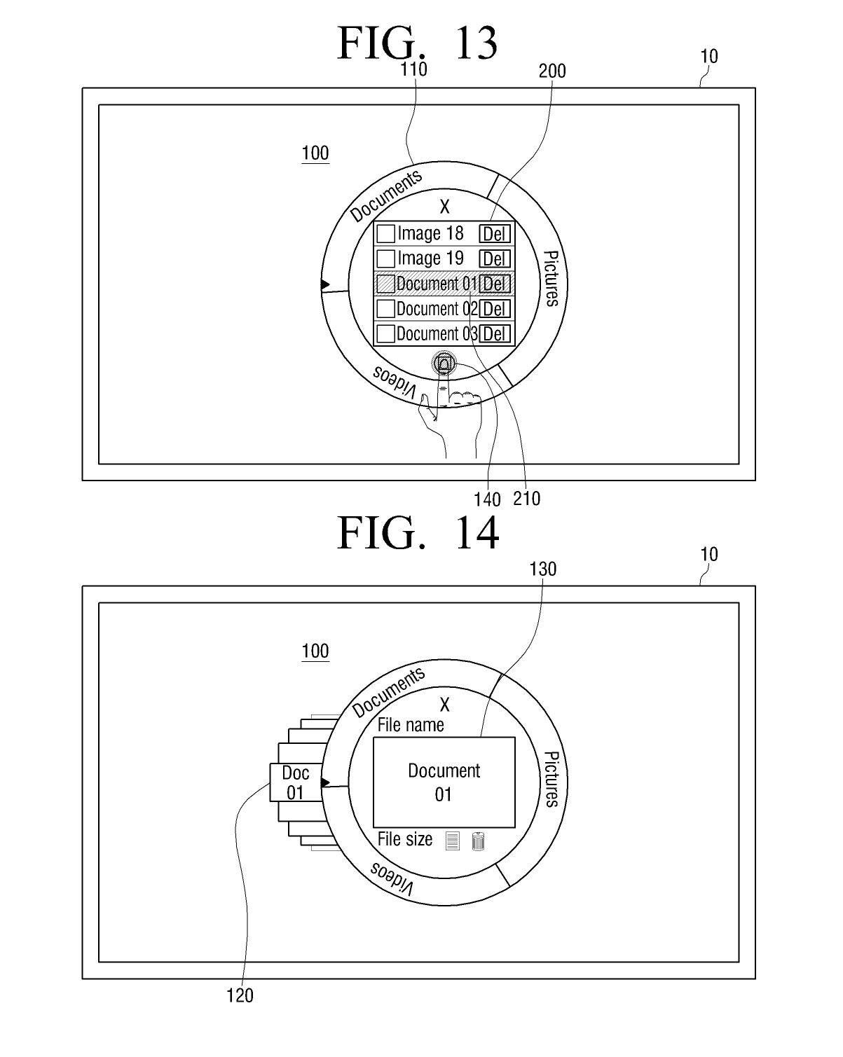

FIG. 14 illustrates a wheel type content explorer in which a content ‘Document 01’ is selected in a preview mode according to an embodiment of the present invention.

Referring to FIG. 11, the wheel type content explorer 100 is in the preview mode state where the content ‘Image 20’ is currently selected. In the thumbnail list 120, the content ‘Image 20’ is displayed in the middle thereof, and the preview window 130 displays ‘Image 20’.

When the user touch the mode switch icon 140, as illustrated in FIG. 11, the device 10 switches the mode of the wheel type content explorer 100 from the preview mode to the list view mode.

Referring to FIG. 12, the content list window 200 displays the content ‘Image 20’ with a highlight 210. Accordingly, even when the wheel type content explorer 100 switches from the preview mode to the list view mode, the selected file is maintained.

In addition, as illustrated in FIG. 12, when the user inputs the panning manipulation along the category wheel 110 while touching the category wheel 110, the device 10 rotates the category wheel 110 according the touch manipulation of the user. The wheel type content explorer after the rotation is illustrated in FIG. 13.

Referring to FIG. 13, the selected file of the wheel type content explorer 100 is changed to the content ‘Document 01’ by the touch manipulation of the category wheel 110 of the user. When the user touches the mode switch icon 140 in the above state as illustrated in FIG. 13, the device 10 switches the wheel type content explorer 100 from the list view mode to the preview mode as illustrated in FIG. 14.

Referring to FIG. 14, the preview window 200 displays the content ‘Document 01’, i.e., even when the wheel type content explorer 100 switches from the list view mode to the preview mode, the selected file is maintained.

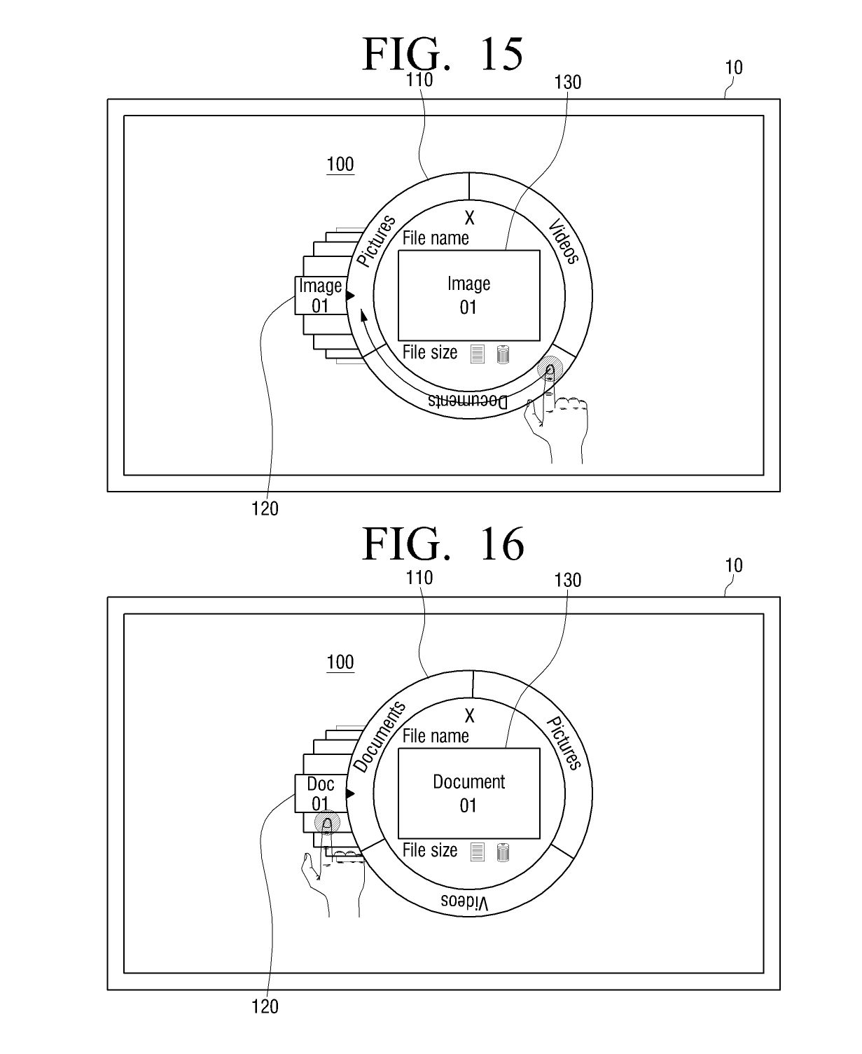

FIG. 15 illustrates a user input manipulation to rotate a category wheel when a content ‘Image 01’ is selected according to an embodiment of the present invention.

FIG. 16 illustrates a tab manipulation to a content ‘Document 02’ of a thumbnail list when a content ‘Document 01’ is selected according to an embodiment of the present invention.

FIG. 17 illustrates a flick manipulation to a left direction to a preview window according an embodiment of the present invention.

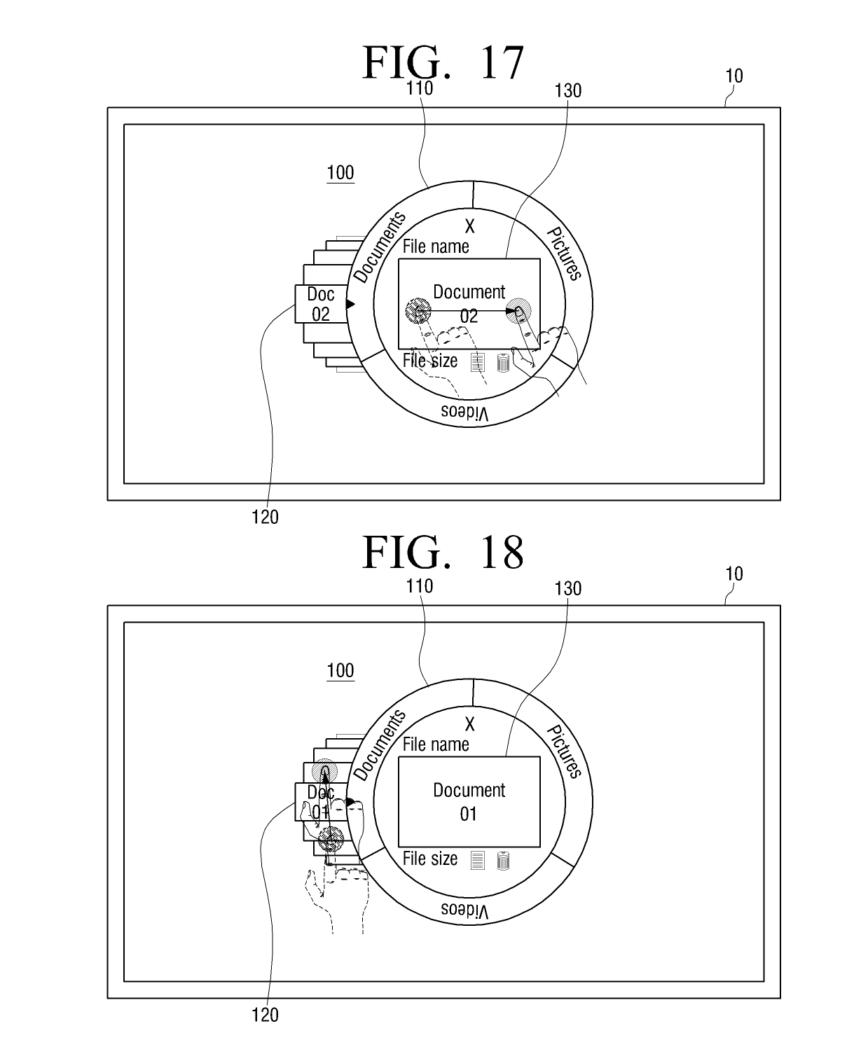

FIG. 18 illustrates a flick manipulation to an up direction to a thumbnail list according an embodiment of the present invention.

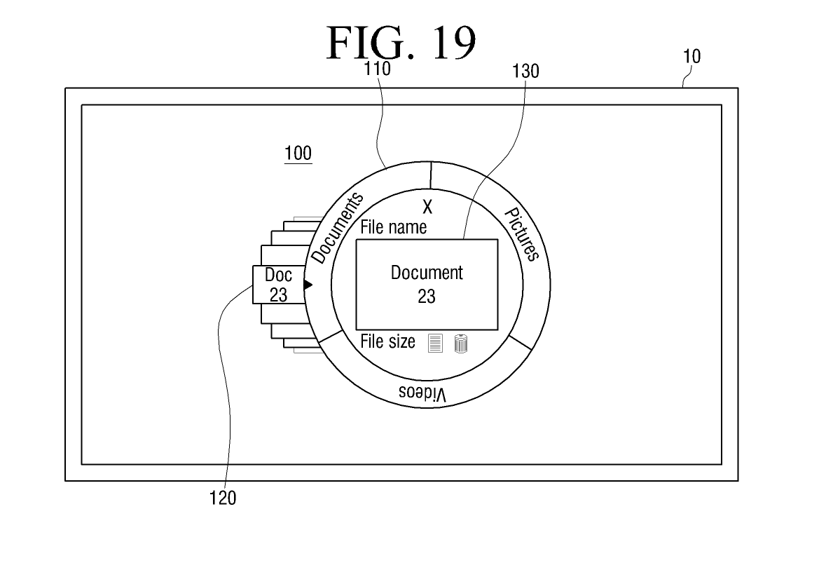

FIG. 19 illustrates a wheel type content explorer in which a content ‘Doc 23’ is selected according to an embodiment of the present invention.

Referring to FIG. 15, content ‘Image 01’ is selected by the wheel type content explorer 100. When the user inputs a panning manipulation in the clockwise direction along the category wheel 110 while touching the category wheel 100, the device 10 rotates the category wheel 100 according to the touch manipulation of the user.

Here, when the user inputs the panning manipulation in the counterclockwise direction along the category wheel 100, the device 10 scrolls a content to a direction toward a content next to the currently selected content. Alternatively, when the user inputs the panning manipulation in the clockwise direction along the category wheel 100, the device 10 scrolls a content to a direction toward a content before the currently selected content. For example, if the current is ‘Image 10’, when the panning manipulation of the counterclockwise direction is input, the content is scrolled in a direction of content ‘Image 11’. When the panning manipulation of the clockwise direction is input, the content is scrolled in the direction of ‘Image 09’.

Referring to FIG. 16, the selected content in the wheel type content explorer 100 is changed to a content ‘Document 1’. That is, the user rotates the category wheel 110 by inputting the panning manipulation along the category wheel 110 to select a content of a desired category.

When the user inputs a tap manipulation to the thumbnail ‘Document 2’ displayed directly below the thumbnail ‘Document 01’ of the thumbnail list 120, as illustrated in FIG. 16, the wheel type content explorer 100 previews ‘Document 02’ as illustrated in FIG. 17.

When the user inputs the flick manipulation to a right direction to the preview window 100 while content ‘Document 02’ is selected as illustrated in FIG. 17, the wheel type content explorer 100 displays a content just before the content ‘Document 02’. That is, when the user inputs the flick manipulation to the right direction to the preview window 100 while content ‘Document 02’ is selected, the wheel type content explorer 100 displays content ‘Document 01’ as illustrated in FIG. 18.

When the user inputs the flick manipulation to a top direction to the thumbnail list 120 in while content ‘Document 01’ is selected, as illustrated in FIG. 18, the device 100 scrolls the thumbnail list 120 to the upper direction. When the thumbnail list 120 is scrolled, the device 10 also enables the category wheel 110 and the preview window 130 to operate. That is, when the thumbnail list 120 is scrolled, the category wheel 110 also rotates and the preview window 130 displays the content ‘Document 01’ as the finally selected content.

Referring to FIG. 19, as a result of scrolling the thumbnail list 120 to the top direction, ‘Document 23’ is selected by the content explorer 100.

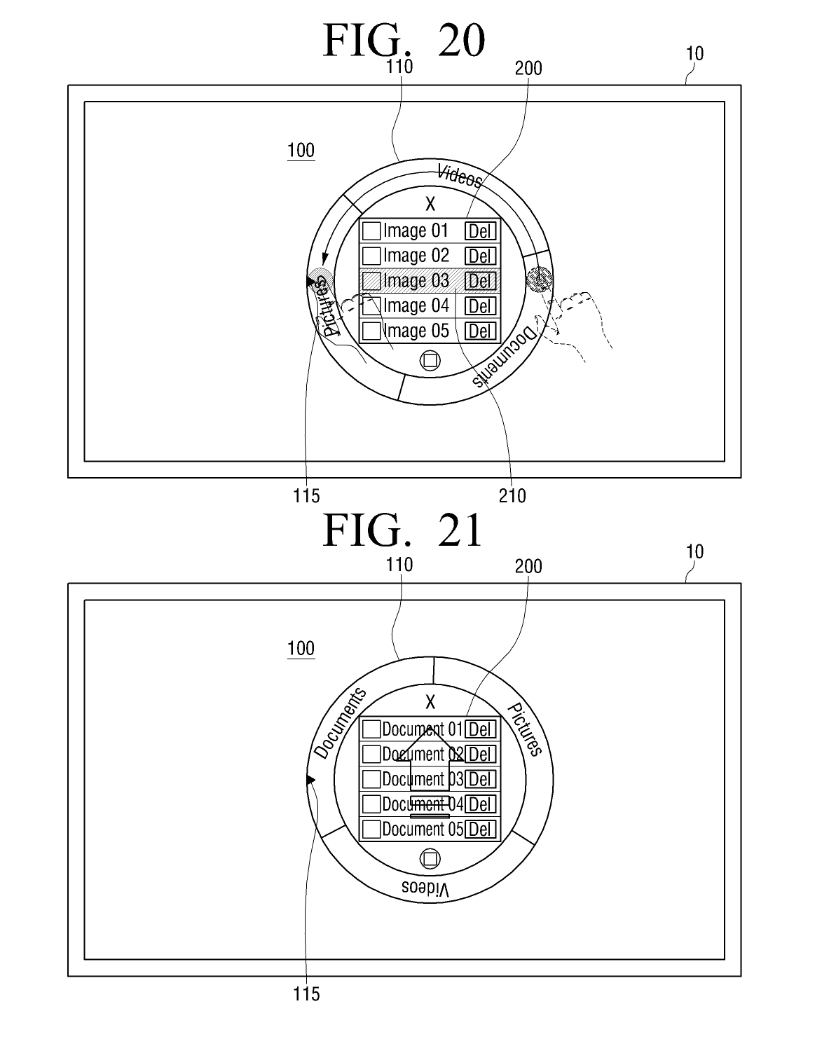

FIG. 20 illustrates a touch manipulation to rotate a category wheel in a counterclockwise direction according to an embodiment of the present invention.

FIG. 21 illustrates a content list window scrolled to a top direction according to an embodiment of the present invention.

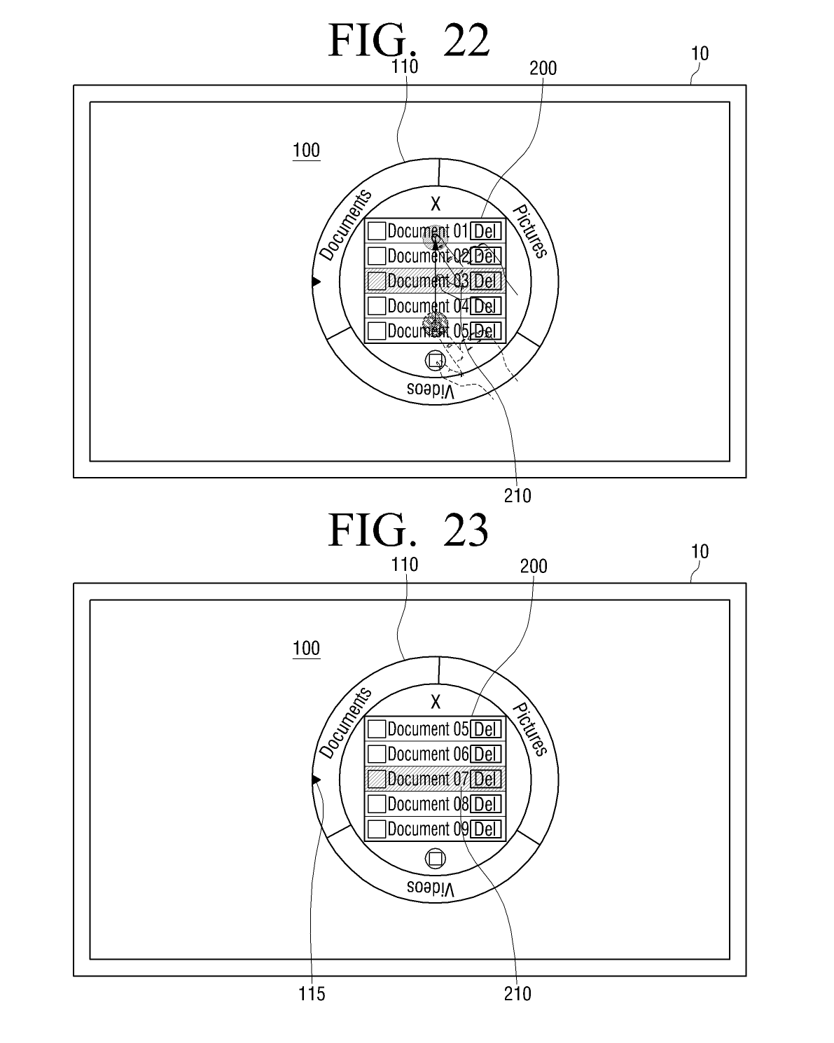

FIG. 22 illustrates a flick manipulation of a top direction to a content list window according to an embodiment of the present invention.

FIG. 23 illustrates a wheel type content explorer when a content ‘Document_07’ is selected according to an embodiment of the present invention.

Referring to FIG. 20 the content explorer 100 is in the list view mode state and the current content mark 115 is located in the ‘Pictures’ region of the category wheel 110. Therefore, the content displayed in the content list window 200 is image content corresponding to the category ‘Pictures’.

When the user wants to select content of the category ‘Documents’, the user inputs the touch manipulation to rotate the category wheel 100 so that the ‘Document’ region of the category wheel 110 is located next to the current content mark 115, as illustrated in FIG. 20. When the user inputs a panning manipulation in the counterclockwise direction along the category wheel 110 as illustrated in FIG. 20, the ‘Documents’ region of the category wheel 110 is moved to the current content mark 115 as illustrated in FIG. 21.

In addition, the content list window 200 is scrolled to the top direction as illustrated in FIG. 21 by the touch manipulation of FIG. 20, and thus, document content corresponding to the category ‘Documents’ are displayed as illustrated in FIG. 22.

Thus, when the panning manipulation of the counterclockwise direction to the category wheel 110 is input, the device 10 scrolls the content list window 200 to the top direction in the list view mode. When the panning manipulation of the clockwise direction to the category wheel 110, the device 10 scrolls the content list window 200 to the bottom direction.

When the user inputs the flick manipulation of the top direction to the content list window 200 as illustrated in FIG. 22, the content list window 200 is scrolled to the top direction. As a result, as illustrated in FIG. 23, the content list window 200 becomes in the state that the content ‘Document_07’ is selected.

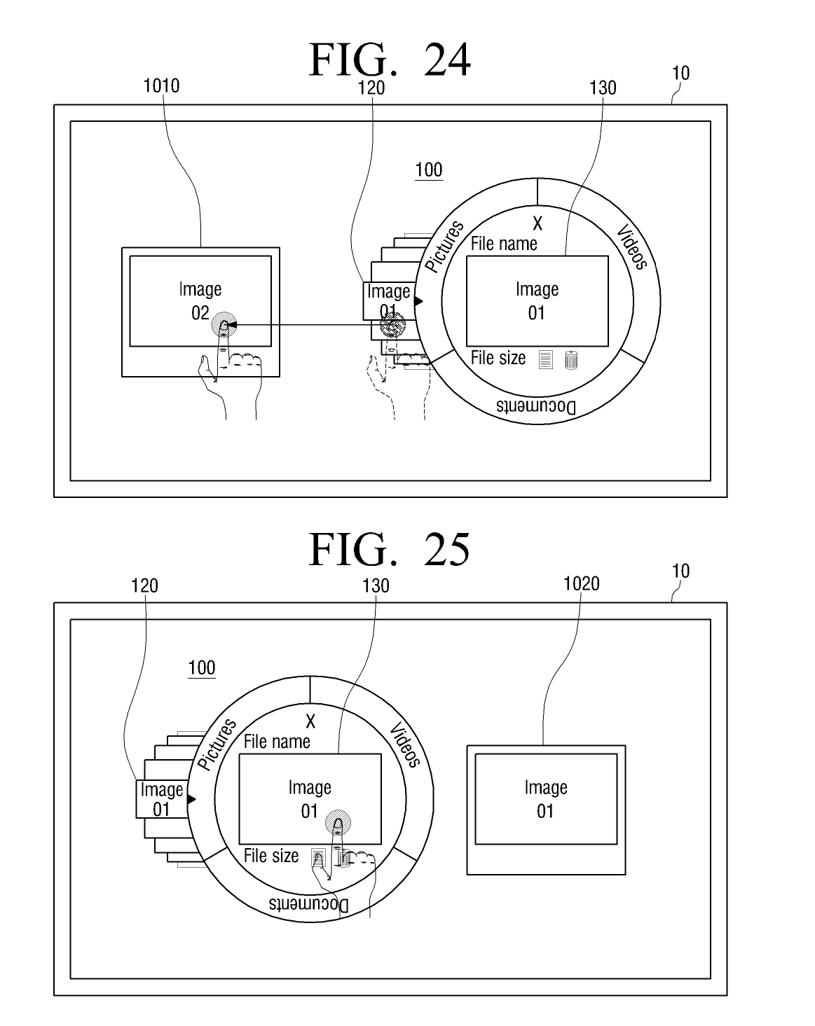

FIG. 24 illustrates a user dragging and dropping ‘Image 2’ of a thumbnail list to a background image with respect to a wheel type content explorer in a preview mode according to an embodiment of the present invention.

Referring to FIG. 24, when the user drags and drops ‘Image 02’ of the thumbnail list 120 to the background image, the device 10 executes the content ‘Image 02’ in a separate execution window 1010 of the background image.

FIG. 25 illustrates a double tap manipulation to a preview window with respect to a wheel type content explorer in a preview mode according to an embodiment of the present invention.

Referring to FIG. 25, when the user inputs the double tap manipulation to the preview window 130 while content ‘Image 01’ is selected, the device 10 executes the content ‘Image 01’ in a separate execution window 1020 of the background image.

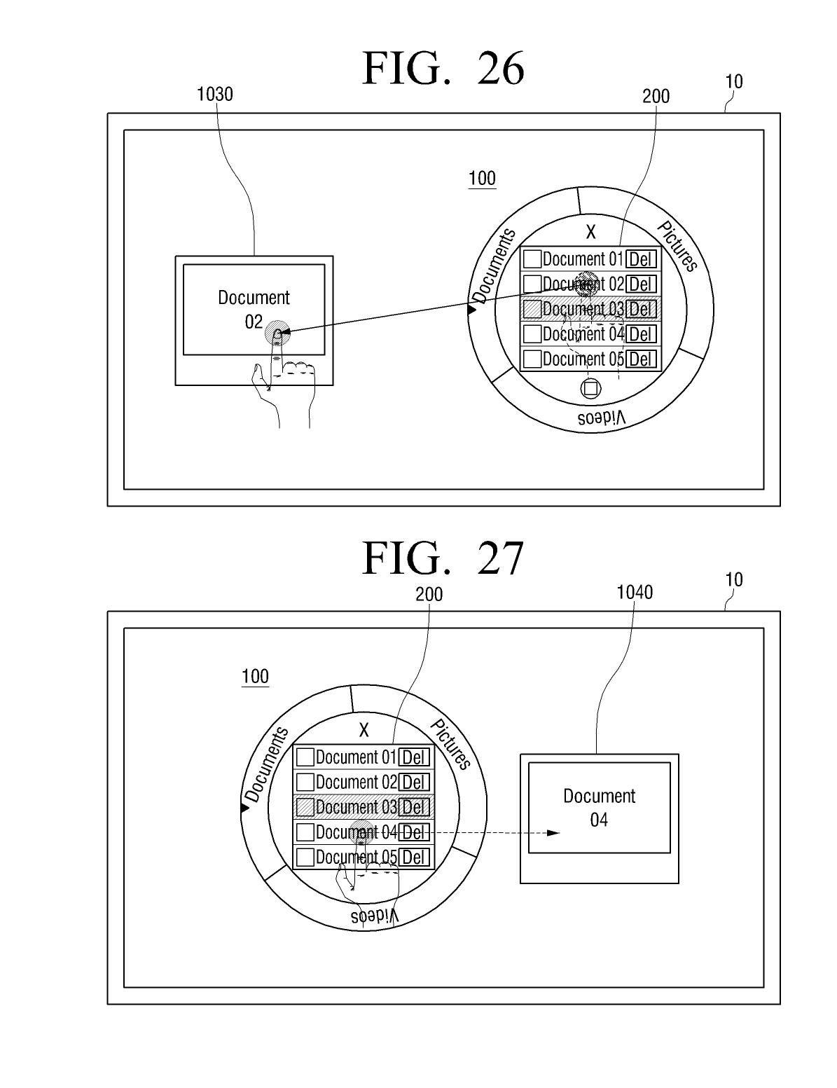

FIG. 26 illustrates a user dragging and dropping ‘Document 02’ of a content list window to a background image with respect to a wheel type content explorer in a list view mode according an embodiment of the present invention.

Referring to FIG. 26, when the user drags and drops the content ‘Document 02’ of the content list window 200 to the background image, the device 10 executes ‘Document 02’ in a separate execution window 1030 of the background image.

FIG. 27 illustrates a double tap manipulation to a ‘Document 04’ of a content list window with respect to a wheel type content explorer in a list view mode according to an embodiment of the present invention.

Referring to FIG. 27, when the user inputs the double tap manipulation to ‘Documents 04’ of the content list window 200, the device 10 executes the content 04′ in a separate execution window 1040 of the background image.

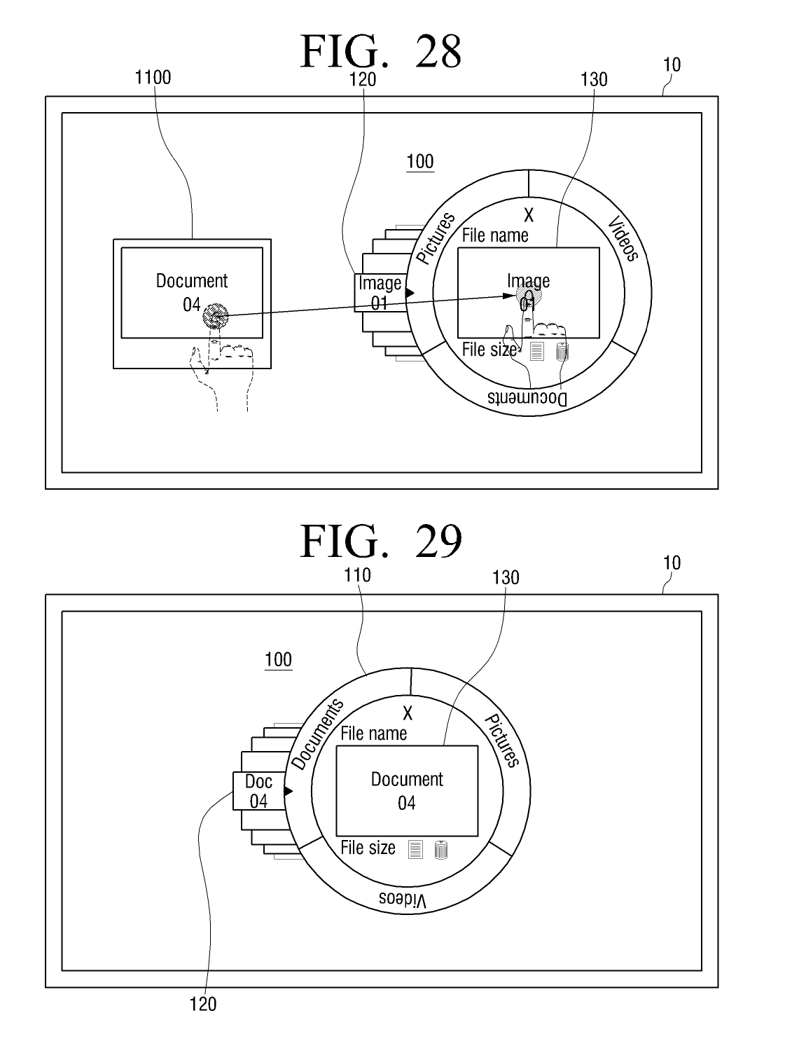

FIG. 28 illustrates a user dragging and dropping content to be executed in a separate window by a wheel type content explorer according to an embodiment of the present invention.

FIG. 29 illustrates a wheel type content explorer when dragged and dropped content is stored according to an embodiment of the present invention.

Referring to FIG. 28, the wheel type content explorer 110 and an execution window 1100 in which the content ‘Document 04’ is executed are displayed in a screen of the device 10. When the user touches the execution window 1100 and drags and drops the content in the wheel type content explorer 100, the content ‘Document 04’ being executed in the execution window 1100 is stored in a storage medium. Therefore, ‘Document 04’ is added to the content displayed in the wheel type content explorer 100.

Referring to FIG. 29, the wheel type content explorer 100 is displayed with the added ‘Document 04’ selected. Thus, it can be seen form FIG. 29 that the category wheel 110 of the wheel type content explorer 100 is rotated to select the ‘Documents’ region compared in FIG. 28 and the thumbnail list 120 is displayed in the state ‘Document 04’ is selected.

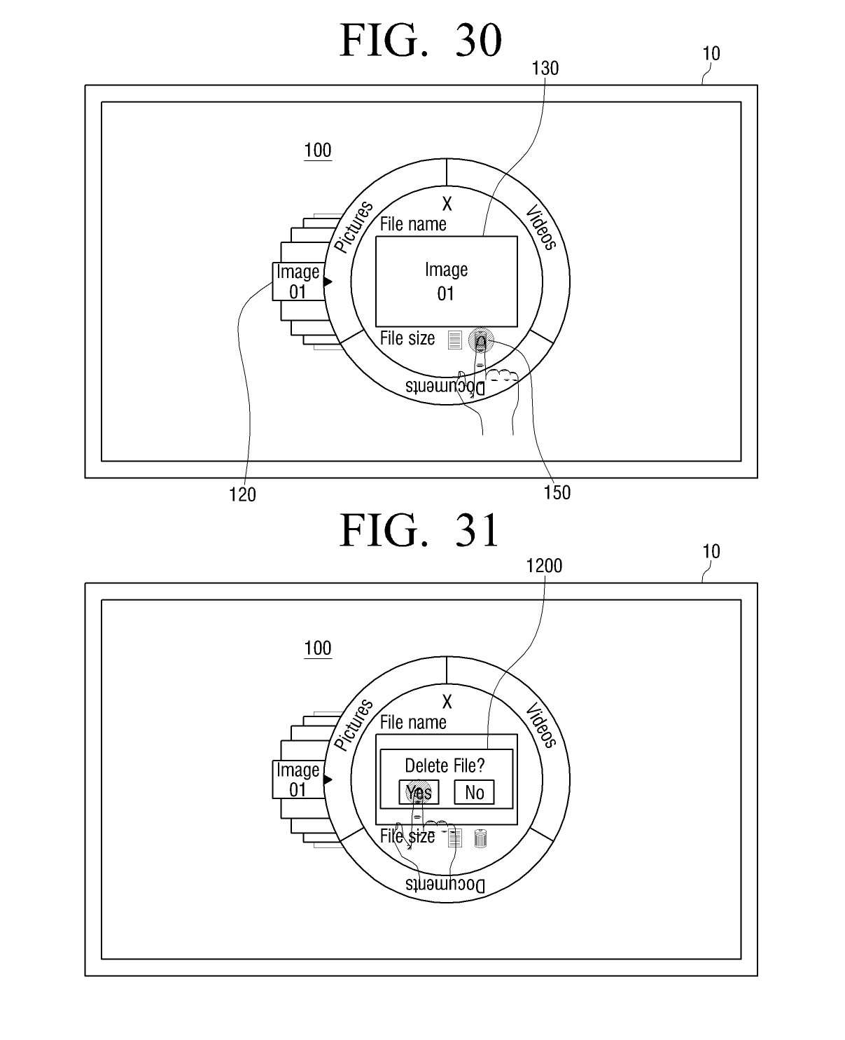

FIG. 30 illustrates a user touching a content delete icon when a content ‘Image 01’ is selected according to an embodiment of the present invention.

FIG. 31 illustrates a screen displaying a delete confirm message according to an embodiment of the present invention.

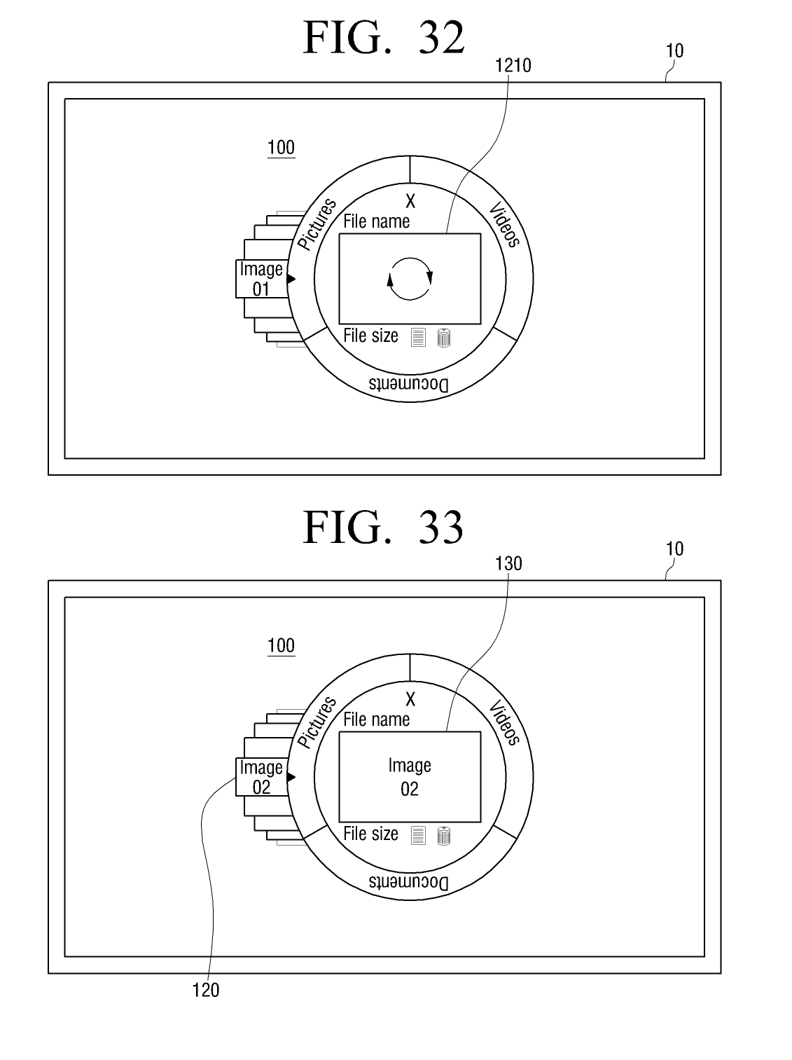

FIG. 32 illustrates a screen displaying a delete animation according to an embodiment of the present invention.

FIG. 33 illustrates a wheel type content explorer after a content ‘Image 01’ is deleted according to an embodiment of the present invention.

Referring to FIG. 30, ‘Image 01’ is currently selected on the wheel type content explorer 100. Thus, when the user touches the delete icon 150, ‘Image 01’ is deleted.

Referring to FIG. 31, the delete confirm message 1200 may be displayed in the content explorer 100. Accordingly, when the user touch Yes, as shown in FIG. 31, the delete animation 1210 indicating that the deletion is progressing is displayed in the content explorer 100, as illustrated in FIG. 32.

Referring to FIG. 33, because ‘Image 01’ is deleted, ‘Image 02’ is selected in the content explorer 100.

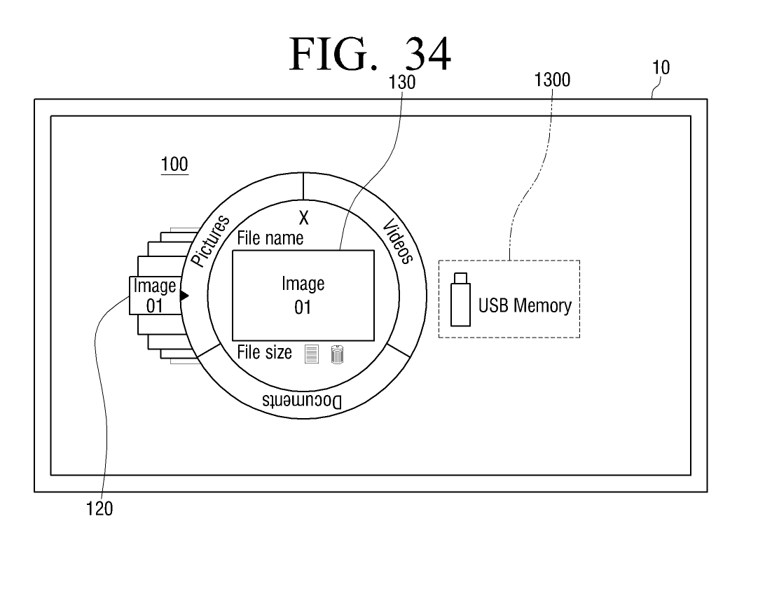

FIG. 34 illustrates a screen displaying a storage medium display icon and a wheel type content explorer according to an embodiment of the present invention.

Referring to FIG. 34, a USB memory is displayed as the storage medium display icon 1300. The storage medium display icon 1300 displays a storage medium in which the content which is to be explored by the wheel type content explorer 100.

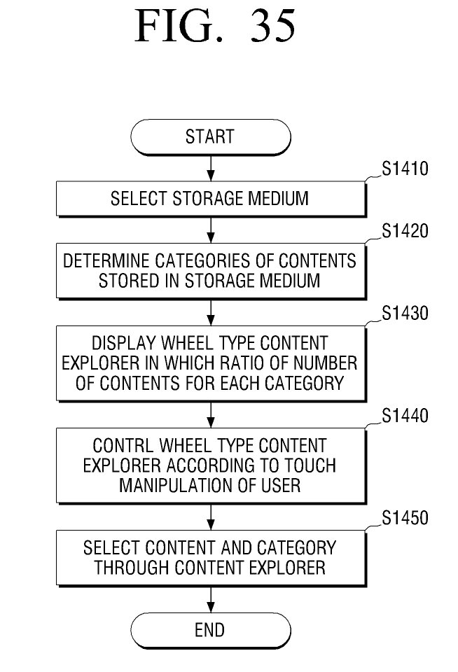

FIG. 35 is a flow chart illustrating a method of providing a GUI according to an embodiment of the present invention.

Referring to FIG. 35, the device 10 selects any one of plurality of storage mediums according to a manipulation of a user in step S1410. As described above, the storage medium may be a storage medium built in the device 10 or an external storage medium, e.g., a hard disc, a memory, a CD-ROM, a DVD, a USB memory, an external memory card, an external hard disc, etc.

In step S1420, the device 10 determines what kinds of categories of content are stored in the storage medium. For example, the device 10 may determine that the category for the content stored in the storage medium includes Picture, Video, and Document.

In step S1430, the device 10 displays the wheel type content explorer 100 indicating an amount of content for each category, as described above.

In step S1440, the device 10 controls the wheel type content explorer 100 according to a touch manipulation of the user. In step S1450, the device 10 selects a category and a content according to the manipulation input by the user through the wheel type explorer 100.

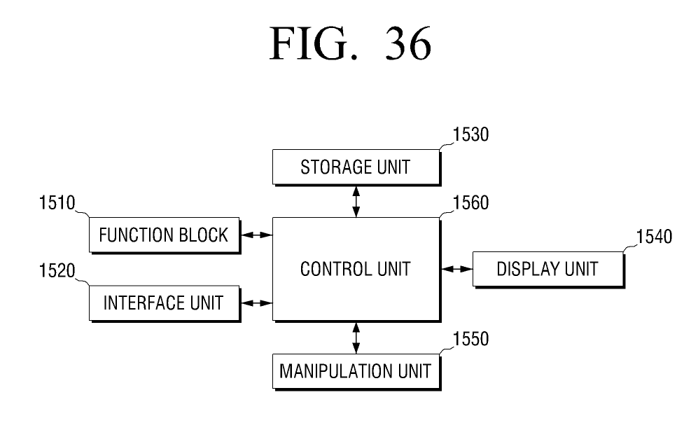

FIG. 36 is a block diagram of a device for providing a GUI according to an embodiment of the present invention.

Referring to FIG. 36, the device 10 includes a function block 1510, an interface unit 1520, a storage unit 1530, a display unit 1540, a manipulation unit 1550, and a control unit 1560.

The function block 1510 performs the native function of the device 10. For example, when the device 10 is a tabletop, the function block 1510 performs tabletop functions, and when the device 10 is a smart board, the function block 1510 performs a function of the smart board for a digital meeting.

The interface unit 1520 connects the device 10 to at least one external storage medium storing a plurality of content. For example, the interface unit 1520 may be connected to a CD-ROM, a DVD, a USB memory, an external memory card, an external hard disc, etc.

The storage unit 1520 is an internal storage medium in which a plurality of content is stored. For example, the storage unit 1520 may be a hard disc, a memory, etc., mounted inside of the device 10.

The display unit 1540 displays an input image and a GUI. For example, the display unit 1540 may be an Liquid Crystal Display (LCD) screen. The display unit 940 displays the wheel type content explorer 100, e.g., as illustrated in FIGS. 2 and 3.

The manipulation unit 1550 receives a manipulation of the user for inputting a specific command. For example, the manipulation unit 1550 may include a button, a wheel, a touch screen, etc. In particular, the manipulation unit 1550 includes the touch screen to manipulate the wheel type content explorer 100.

The control unit 1560 performs the steps of the flow chart illustrated in FIG. 35 to enable the device 10 to provide the wheel type content explorer in a GUI item form. Further, the control unit 1560 controls the device to provide functions of the wheel type content explorer 100 described above with reference to FIGS. 1 to 34.

The device described herein may be any device including a display. For example, the device may be a tabletop, a smart board, a television (TV), a notebook computer, etc.

Further, although the content explorer 100 has been illustrated as having a wheel shape, the content explorer 100 may also be embodied in other shapes. For example, the device may provide the content explorer 100 in which each category is displayed in a border of a polygon having the same number of sides as the number of kinds of the categories. In this case, a length of each side of the polygon may be determined according to the number of contents corresponding to a corresponding category.

While the present invention has been shown and described with reference to certain embodiments thereof, it will be understood by those skilled in the art that various changes in form and details may be made therein without departing from the spirit and scope of the present invention as defined by the appended claims.

1-20. (canceled)

21. A method of providing a Graphic User Interface (GUI) by a display device, the method comprising:
accessing a storage medium including stored content;
displaying a GUI item including category indicators along a border region thereof, each of the category indicators corresponding to a type of content, spanning a predetermined range of the boarder region, and including content from the accessed storage medium;
displaying a content preview based on a user manipulation of the GUI item; and
selecting content from the content preview through the GUI item.

22. The method of claim 21, wherein the predetermined range for each category indicator is determined according to a ratio of an amount content included in a specific category indicator to a total amount of the content stored in the storage medium.

23. The method of claim 22, wherein when the ratio of the amount of content of the specific category to the total amount of the content is lower than a critical ratio, the predetermined range of the specific category indicator is determined to correspond to the critical ratio.

24. The method of claim 21, wherein the GUI item includes a wheel, and
wherein each category indicator spans the border region of the wheel by the predetermined range.

25. The method of claim 21, wherein the displaying the GUI item comprises one of:
displaying the GUI item in a preview mode in which the content preview includes a content image of content selected; and
displaying the GUI item in a list view mode in which the content preview includes a content list.

26. The method of claim 25, wherein, when the preview mode is set, the GUI item includes a preview window for displaying the content preview.

27. The method of claim 25, wherein, when the preview mode is set, the GUI item includes a thumbnail list that displays a preset number of content including the content selected by the GUI item in a thumbnail form.

28. The method of claim 25, wherein, when the list view mode is set, the GUI item includes a content list window for displaying a preset number of content in the content list.

29. The method of claim 21, further comprising displaying an icon indicating the accessed storage medium.

30. A device for displaying content via a Graphic User Interface (GUI), comprising:
a storage unit for storing the content;
an interface unit connected to an external storage medium; and
a control unit that accesses the storage medium including the stored content,
displays a GUI item including category indicators along a border region thereof, each of the category indicators corresponding to a type of content, spanning a predetermined range of the boarder region, and including content from the accessed storage medium,
displays a content preview based on a user manipulation of the GUI item, and
selects content from the content preview through the GUI item.

31. The device of claim 30, wherein the control unit determines the predetermined range for each category indicator according to a ratio of an amount content included in a specific category indicator to a total amount of the content stored in the storage medium.

32. The device of claim 31, wherein, wherein when the ratio of the amount of content of the specific category to the total amount of the content is lower than a critical ratio, the control unit determines the predetermined range of the specific category indicator to correspond to the critical ratio.

33. The device of claim 30, wherein the GUI item includes a wheel, and
wherein the control unit controls each category indicator to span the border region of the wheel by the predetermined range.

34. The device of claim 30, wherein the control unit sets the GUI item to one of; a preview mode in which the content preview includes a content image of content selected, and a list view mode in which in which the content preview includes a content list.

35. The device of claim 34, wherein, when the preview mode is set, the GUI item includes a preview window for displaying the content preview.

36. The device of claim 34, wherein, when the preview mode is set, the GUI item includes a thumbnail list that displays a preset number of content including the content selected by the GUI item in a thumbnail form.

37. The device of claim 34, wherein, when the list view mode is set, the GUI item includes a content list window for displaying a preset number of content in the content list.

38. The device of claim 30, wherein a control unit controls an icon indicating the accessed storage medium to be displayed.

39. A Graphic User Interface (GUI) for displaying and selecting content, comprising:
a wheel in which different categories of content stored in a storage medium are displayed;
a current content mark for indicating content included one of the different categories, based on the rotation of the wheel; and
a preview window for displaying a preview of the content indicated by the current content mark.

40. The GUI of claim 39, wherein the preview comprises one of:
displaying a content image of the content; and
displaying a content list including the content.
